(19) United States
(12) Patent Application Publication
(10) Pub. No.: US 2004/0242833 A1
(43) Pub. Date: Dec. 2, 2004

(54) Production of masked isocyanates particularly masked polyisocyanates

(76) Inventor: Jean-Marie Bernard, Mornant (FR)

Correspondence Address: BURNS DOANE SWECKER & MATHIS L L P, POST OFFICE BOX 1404, ALEXANDRIA, VA, 22313-1404, US

(21) Appl. No.: 10/481,504

(22) PCT Filed: Jun. 25, 2002
(86) PCT No.: PCT/FR02/02198

(30) Foreign Application Priority Data
Jun. 25, 2001 (FR) 0108351

(51) Int. Cl. C08G 18/81

(52) U.S. Cl. 528/45

(57) ABSTRACT

The invention relates to a method for the production of masked (poly)isocyanates using a masking agent with a C═N bond and a labile hydrogen atom on the α atom relative to the nitrogen of the C═N group, characterised in comprising the following steps: a) preparation of a masking agent with a C═N bond and a labile hydrogen atom on the α atom relative to the nitrogen of the C═N group which may be obtained by condensation of an aldehyde or ketone precursor with a nitrogen-containing precursor which has a functional group reactive towards the carbonyl moiety of the aldehyde or ketone, in an aqueous, organic or hydroorganic medium with liberation of water of condensation; b) in situ reaction of the masking agent with a (poly)isocyanate component for masking to give said (poly)isocyanates which are totally or partially masked.

The invention relates to the production of blocked isocyanates, particularly blocked polyisocyanates.

The invention relates more particularly to a method in which directly linked together are the production of the blocking agent and the blocking of the (poly)isocyanates, strictly speaking, without isolation of the intermediate reaction product.

Polyisocyanates blocked by means of a blocking agent of the oxime type are described in SU 727 637, SU 78-2665978, U.S. Pat. No. 4,868,298 and DE 2342775.

In addition, SU 414259 and EP 159 117 describe polyisocyanates in which the isocyanate functions are blocked with a pyrazole.

Many other methods for blocking isocyanates are described in the literature; all these methods comprise two steps: a first step of production and isolation of the blocking agent and a second step in which the blocking agent is reacted with the isocyanate functions present in the isocyanate composition to be blocked.

The aim of the present invention is to prepare, in a controlled manner, a blocked (poly)isocyanate composition.

The aim of the present invention is also to provide a partially or totally blocked (poly)isocyanate composition, in organic, aqueous-organic or aqueous medium in the form of a solution, suspension or emulsion, in which the amount of blocking groups can be determined in advance, which is obtained directly using the compounds which are precursors of the blocking agents without losses of intermediate compounds and without intermediate isolation of the blocking agent.

The studies by the inventors on which the present invention is based have made it possible to discover that, for a type of particular blocking agent, it is possible to produce blocked polyisocyanates by a one-step method using precursors of the blocking agents, without the lack of isolation of the blocking agent interfering with the blocking reaction.

A subject of the invention is a method for producing blocked (poly)isocyanates using a blocking agent exhibiting a C═N bond and having a mobile hydrogen atom on the atom in the α-position relative to the nitrogen atom of the C═N group, characterized in that it comprises the following steps:

a) producing a blocking agent exhibiting a C═N bond and having a mobile hydrogen atom on the atom in the α-position relative to the nitrogen atom of the C═N group, which can be obtained by condensation of a precursor consisting of an aldehyde or a ketone with a nitrogen-containing precursor comprising a functional group reactive toward the carbonyl function of the aldehyde or of the ketone, in aqueous, organic or aqueous-organic medium, with release of condensation water;

b) reacting the blocking agent, in situ, with a (poly)isocyanate composition to be blocked so as to obtain said totally or partially blocked (poly)isocyanates.

Advantageously, said mobile hydrogen atom in the α-position relative to the nitrogen atom of the C═N group is carried by an oxygen or nitrogen atom.

The expression “which can be obtained by condensation of a precursor consisting of an aldehyde or a ketone with a nitrogen-containing precursor comprising a functional group reactive toward the carbonyl function of the aldehyde or of the ketone” is intended to mean that the blocking agent can be, but is not necessarily, obtained by this pathway, in the context of the method of the invention.

The condensation reactions between precursors of the type mentioned above are equilibrated reactions, the condensation of the carbonyl precursors being in equilibrium with the blocking agent-hydrolyzing reaction (Textbook of Practical Organic Chemistry; Vogel's; 5^{th} edition; John Wiley & Sons; p. 1228).

In addition, ketone derivatives often have a mobile hydrogen atom which can induce parasitic reactions during condensation with a nitrogen-containing derivative.

The method of the invention consequently exhibits a surprising characteristic insofar as those skilled in the art would expect the starting products which have not reacted and also the troublesome by-products present in the reaction medium at the end of step a), firstly, to interfere with the blocking reaction and, secondly, to have negative effects on the qualities of coatings obtained during the application of the blocked (poly)isocyanate compositions of the invention, and, as a result, would have considered the careful separation of the blocking agent from the reaction medium for preparing it to be an obligatory step before carrying out the actual blocking. Among the by-products present in the reaction medium at the end of step a), and which might be considered as troublesome in view of the prior art, mention may, for example, be made of the water formed during the reaction for preparing the blocking agent.

The blocking agents which are suitable for the method of the invention are preferably oximes, pyrazoles and hydrazones, the latter encompassing semi-carbazones.

In general, the blocking agents of the invention correspond to the following general formulae I to III:

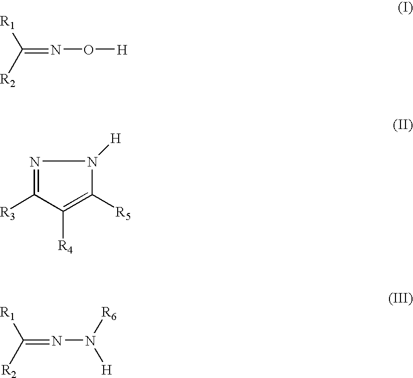

in which:

R₁ and R₂ are selected from an alkyl group, perhaloalkyl group, cycloalkyl group, aryl group, alkoxyl group, acyl group, acyloxyl group, aryloxyl group, alkoxycarbonyl group and aryloxycarbonyl group, optionally substituted, and/or interrupted with one or more hetero atoms selected from S, O and N, preferably O;

R₃, R₄ and R₅ are selected from a hydrogen atom, and an alkyl group, perhaloalkyl group, cycloalkyl group, aryl group, alkoxy group, aryloxy group, acyl group, acyloxy group, alkoxycarbonyl group and aryloxycarbonyl group, optionally substituted, and/or interrupted with one or more hetero atoms selected from S, O and N, preferably O;

R₆ represents a hydrogen atom, an alkyl group, cycloalkyl group or aryl group, as defined above, or a carbamoyl group of formula CONR₇R₈, R₇ and R₈ possibly being selected, independently of one another, from an alkyl group, cycloalkyl group or aryl group, which are optionally substituted.

In formulae I, II and III above, said mobile hydrogen atom in the α-position of the nitrogen of the C═N group is underlined in bold.

Preferably, one from R₁ and R₂ or R₃, R₄ and R₅ represents an alkoxy, aryloxy, acyloxy, alkoxycarbonyl or aryloxycarbonyl group. When, in formulae I, II and III the groups R₁, R₂, R₃, R₄ and R₅ represent a hydrocarbon-based chain interrupted with a hetero atom, there are preferably less than two simple bonds C—O, C—S and/or C—N on a single carbon atom.

The groups R₁ to R₆ advantageously contain at most 15 carbon atoms, preferably at most 10 carbon atoms.

Step a) for synthesizing the blocking agent uses reactions known to those skilled in the art.

Thus, the reaction between a 1,3-diketone (or β-diketone) with hydrazine in basic medium so as to produce a substituted pyrazole is in particular described in “Vogel's Textbook of Practical Organic Chemistry” (B. S. Furniss, A. J. Hannaford, P. W. G. Smith, A. R. Tatchell), 5^{th} edition.

In addition, the reaction between hydroxylamine and a ketone is a well known reaction described in particular in Advanced Organic Chemistry by Jerry March, 3^{rd} edition, J. Wiley & Sons, pp 534, 729, 805 and 1170.

The preparation of hydrazones from hydrazine or from one of its derivatives and of a ketone or a keto alcohol is also well known to those skilled in the art and described in particular in (Textbook of Practical Organic Chemistry; Vogel's; 5^{th} edition; John Wiley & Sons; p. 1245).

For the purpose of the invention, the term “alkyl” group is generally intended to mean a saturated, linear or branched hydrocarbon-based group having only hydrogen and carbon atoms and generally having from 1 to 20, preferably from 1 to 10, more preferably from 1 to 6, carbon atoms.

The term “cycloalkyl” is intended to mean an alkyl group as defined above, containing a monocycle and advantageously having from 3 to 12 carbon atoms, for example a cyclopropyl or cyclopropylmethyl group.

The term “aryl” group is intended to mean a monocyclic or bicyclic hydrocarbon-based aromatic group comprising from 6 to 10 carbon atoms.

For the purpose of the invention, the term “alkoxy” is intended to mean a group —O-alkyl, alkyl being as defined above, encompassing in particular cycloalkyl and aralkyl.

For the purpose of the present invention, the term “aryloxy” is intended to mean a group —O-aryl, aryl being as defined above.

For the purpose of the invention, the term “acyl” is intended to mean a group —C(O)-alkyl or —C(O)-aryl, alkyl and aryl being as defined above, and alkyl encompassing cycloalkyl and aralkyl.

For the purpose of the invention, the term “acyloxy” is intended to mean a group —O—C(O)-alkyl or —O—C(O)-aryl, alkyl and aryl being as defined above, and alkyl encompassing cycloalkyl and aralkyl.

For the purpose of the invention, the term “alkoxycarbonyl” is intended to mean a group —C(O)—O-alkyl, alkyl being as defined above, and encompassing cycloalkyl and aralkyl.

For the purpose of the present invention, the term “aryloxycarbonyl” is intended to mean a group —C(O)—O-aryl, aryl being as defined above.

The substituents of the alkyl groups may be aryl, OR₉, SR₉, NR₉R₁₀, PO₄R₉R₁₀ or polyoxyethylene groups, R₉ and R₁₀, which may be identical or different, representing an alkyl, cycloalkyl or aryl group as defined above.

The substituents of the aryl groups may be alkyl, aryl, OR₉, SR₉, NR₉R₁₀, PO₄R₉R₁₀ or polyoxyethylene groups, in which R₉ and R₁₀, which may be identical or different, represent an alkyl, cycloalkyl or aryl group as defined above.

The preferred groups R₁ and R₂ are alkyl groups, in particular methyl and ethyl groups, or one of R₁ and R₂ is an alkoxy or carbonyl group, in particular methyloxycarbonyl or aryloxycarbonyl group.

The preferred groups R₃, R₄ and R₅ are a hydrogen atom or an alkyl group, in particular a methyl or aryl group, especially a phenyl group. Preferably, at least one group of R₃, R₄ and R₅ represents a hydrogen atom.

Preferred compounds of formula I are methyl ethyl ketoxime (MEKO), benzophenone oxime, alkyl pyruvate oximes, in particular methyl pyruvate oxime (POME) or ethyl pyruvate oxime, and cyclohexanone oxime.

Oximes derived from α-diketones are not preferred.

Preferred compounds of general formula II are pyrazole, 3-methylpyrazone and 3,5-dimethylpyrazole.

Preferred compounds of general formula III are acetaldehyde hydrazone, acetone methylhydrazone, cyclopentanone methylhydrazone and methyl ethyl ketone methylhydrazone.

According to a first embodiment of the invention, in step a), hydroxylamine is reacted with a ketone, an α-keto ester, or even a β-keto ester, so as to obtain an oxime.

In this case, the ketones encompass hydroxycarbyloxycarbonyl, in particular alkyloxy- or aryloxycarbonyl or keto esters, and preferably α-keto esters, in particular those described in WO 97/24386, ketonitriles, dialkoylamides, aldols and ketols, including sugars and their derivatives and cyclic esters, especially lactones and also keto alcohols, in which the alcohol function is preferably secondary or tertiary.

In a second embodiment of the invention, in step a), hydrazine is reacted with a β-diketone so as to obtain a pyrazole compound.

According to a third embodiment of the invention, in step a), hydrazine or a hydrazine derivatives is reacted with a ketone or a preferably secondary or tertiary ε-keto alcohol, or with a ketolactone, so as to obtain a hydrazone.

More precisely, the oximes corresponding to general formula I can be obtained by condensing one mole of hydroxylamine with one mole of ketone of general formula Ia:

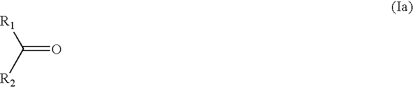

in which R₁ and R₂ are as defined above,

with elimination of one mole of water.

The reaction is generally carried out at between pH 3 and 10, advantageously between 4 and 6, preferably at pH 5±0.5.

The pyrazoles of general formula II are obtained by reaction with one mole of hydrazine:

NH₂—NH₂

with one mole of β-diketone of general formula IIa, with elimination of two moles of water:

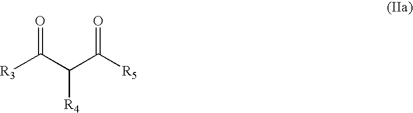

R₃, R₄ and R₅ being as defined above.

The hydrazones of general formula III are obtained by reaction of one mole of hydrazine of general formula IIIa:

NH₂—NHR₆ (IIIa)

where R₆ is as defined above, with one mole of ketone of general formula (Ia) as defined above, with elimination of one molecule of water.

The first step of the method of the invention is carried out in a manner known per se, in organic, aqueous-organic or aqueous medium. The choice of the solvent is guided by that of the final formulation.

If it is desired to obtain the (poly)isocyanate composition in organic medium, use will be made of a conventional solvent of formulations of this type, in particular an ester (n-butyl acetate), an ether or a hydrocarbon, preferably an aromatic hydrocarbon, for example SOLVESSO®.

If it is desired to obtain a composition in aqueous-organic medium, a water-miscible organic solvent will be selected. An ether, an alcohol or an amide, such as NMP, will be preferred.

If it is desired to obtain an aqueous composition, the reaction will be entirely carried out in water.

In the context of the present invention, it has been shown, surprisingly, that the reaction may be carried out in a biphasic manner without hindering the condensation of the carbonyl products with the nitrogen-containing products. It should be understood that the reaction medium may be homogeneous or heterogeneous, without hindering the condensation of the carbonyl products with the nitrogen-containing products and without hindering the subsequent reaction of blocking the (poly)isocyanate composition.

In each of these cases, it should be understood that the presence of the water formed during the reaction for preparing the blocking agent does not constitute an element which hinders the blocking reaction per se. The addition of water to the reaction medium may also be envisioned. The water content of the reaction medium will thus advantageously be equal to one times, preferably 1.5 times, more preferably 2 times, the amount of water formed during the preparation of the masking agent.

The reaction temperature is generally between 20 and 100° C., and is preferably around 50° C.

The duration of the reaction is generally of the order of 30 minutes to 8 hours, advantageously of the order of 30 minutes to 4 hours.

The procedure is generally carried out with a ratio of equivalents of functions

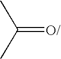

nitrogen-containing functions of the precursor of at most equal to 0.9, advantageously of 1, preferably with an excess of equivalents of nitrogen-containing functions of the precursor relative to equivalents of functions

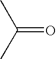

ranging up to 20%, preferably 10%. The procedure may also be carried out with a slight excess of function

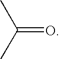

However, this embodiment is not preferred since the products have a tendency to turn yellow, which may prove to be troublesome for some uses of the blocked (poly)isocyanate compositions of the present invention.

At the end of the first step, a reaction product of general formula I, II or III, water derived from the condensation of the carbonyl reagent with the nitrogen-containing reagent and, where appropriate, an organic solvent are obtained.

In a first embodiment of the invention, step a) is carried out in organic aqueous-organic medium. The water produced by condensation of the compounds of general formula I, II or III with the corresponding carbonyl compound may form an aqueous phase which may optionally be eliminated, for example by separation by settling out, or any other method known to those skilled in the art, and the reaction product of general formula I, II or III may be recovered from the organic phase, which is not necessarily dry, either in solution or in suspension. This does not imply complete elimination of the water.

In a second embodiment of the invention, the water produced in step a) is not eliminated and the reaction product is obtained in solution or suspension in aqueous or aqueous-organic medium, depending on whether or not the initial reaction medium contains an organic solvent.

In a third embodiment of the invention, the reaction is carried out entirely in aqueous medium. In this case, the equilibrium should be shifted, for example by precipitation of the compound formed. In general, this embodiment is not preferred given the fact that the equilibrium is shifted toward the starting compounds.

The blocking step b) is carried out directly on the reaction medium obtained at the end of step a), without subsequent treatment thereof, other than, where appropriate, a step of separation by settling out, but, in all cases, without isolation of the intermediate blocking product.

Since the reaction of the isocyanate with the blocking agent is exothermic, the reaction temperature increases according to the nature of the blocking agent, of the isocyanate compound and of the concentration of reagents in the medium.

According to a first procedure, the isocyanate for which blocking of the NCO functions is sought, is introduced into the reaction medium, containing the blocking agent, preferably gradually and continuously, in such a way as to maintain the temperature of the reaction medium below the temperature of release of the blocking group, preferably below 100° C., and better still below 80° C.

The isocyanate is generally introduced at a temperature of between 20 and 120° C., preferably in the region of 50° C. It is, however, also possible to heat the reaction medium if it is desired to accelerate the reaction.

According to a second procedure, the blocking agent of step a) is added to the (poly)isocyanate composition to be blocked.

When the (poly)isocyanate is added to the blocking agent, all the isocyanate functions are blocked insofar as the functional group of the blocking agent reacting with the isocyanate/isocyanate functions is ≧1.

In the opposite case, it is possible to stop the addition of the blocking agent to the (poly)isocyanate and to obtain partially blocked (poly)isocyanates, the blocking agent/isocyanate ratio being less than 1 and the distribution of the blocking agents being random, i.e. virtually all the blocking agents block all or some of the isocyanate functions of each (poly)isocyanate species present in the initial (poly)isocyanate composition. A second blocking agent or a chain extender (diol, prepolymer, etc.) can then very easily be introduced.

In the two cases, there may be formation of urea and, possibly, of biuret by reaction of the isocyanate with H₂O, but, according to the present invention, this reaction is clearly minor with respect to the blocking reaction unless it is voluntary (addition of chain extender or of catalyst). The free NCO functions are assayed by the dibutylamine method, or are followed by infrared at 2250 cm⁻¹ (NCO band).

The blocking reaction may be promoted by adding a catalyst, but this addition is not necessary.

According to a particular embodiment of the invention, use may be made, for step a), of two different carbonyl compounds which will produce two different oximes, for example MEKO and POME, or two different pyrazoles, for example pyrazole and 3-methylpyrazole, and the blocking may subsequently be carried out with the mixed blocking agents obtained.

It is also possible to select the pairs of compounds Ia and/or IIa/hydrazine or hydrazine derivatives so as to obtain a mixture of a blocking agent of one type (oxime, for example) and a blocking agent of a different type (pyrazole, for example), which are subsequently reacted with the (poly)isocyanate composition to be blocked so as to obtain mixed block (poly)isocyanates.

The isocyanate which is reacted with the blocking agent may be a monomeric isocyanate, in particular a diisocyanate or a triisocyanate. Preferred monomers are those in which at least one of the isocyanate functions is aliphatic, i.e. carried by an (sp³) hybridized carbon which also advantageously carries at least one, preferably two, hydrogen atoms.

Mention may in particular be made of the following monomeric isocyanates:

1,6-hexamethylene diisocyanate,

1,12-dodecane diisocyanate,

cyclobutane-1,3-diisocyanate,

cyclohexane-1,3- and/or 1,4-diisocyanate,

1-isocyanato-3,3,5-trimethyl-5-diisocyanatomethylcyclohexane (isophorone diisocyanate, or IPDI),

2,4- and/or 2,6-hexahydrotoluylene diisocyanate,

hexahydro-1,3- and/or -1,4-phenylene diisocyanate,

perhydro-2,4′- and/or -4,4′-diphenylmethane diisocyanate,

1,3- and/or 1,4-phenylene diisocyanate,

2,4- and/or 2,6-toluylene diisocyanate,

diphenylmethane-2,4′- and/or -4,4′-diisocyanate,

4-isocyanatomethyloctylene diisocyanate (LTI or NTI),

triphenylmethane-4,4′,4″-triisocyanate,

1,3-bisisocyanatomethylcyclohexane,

bisisocyanatomethylnorbornane (NBDI),

2-methylpentamethylene diisocyanate.

The isocyanate may also be a product of homocondensation or heterocondensation of alkylenediisocyanates, in particular comprising products of the “BIURET” type and of the “TRIMER” type, or even the “PREPOLYMER” type, with isocyanate functons, in particular comprising urea, urethane, allophanate, ester or amide functions, or mixtures of products mentioned above.

The isocyanate may also be a product of precondensation with a compound having at least one function with a mobile hydrogen, in particular a polyol or a polyamine.

A subfamily of compounds of this type is aimed at the polyisocyanates derived from prepolymerization with alcohols, in general triols, or polyamines, in particular triamines, with a polyisocyanate, in general diisocyanate, the amount of isocyanate functions being greater than that of the functions with mobile hydrogen (such as the amines and/or alcohols), such that, at the end of the prepolymerization, the number of residual isocyanate functions per molecule is on average greater than two, advantageously at least equal to 2.5, preferably at least equal to three.

Mention may be made, by way of example, of alcohol compounds, monoalcohols such as methanol, ethanol, propanol or butanol, polyols having from 2 to 30 carbon atoms, such as glycerol, propylene glycol, butanediol, trimethylolpropane, pentaerythritol or diglyme, phenols, such as phenol, cresols, xylenols, and nonylphenol.

As isocyanate compound, preference is particularly given to 1,6-hexamethylene diisocyanate (HDI), the cyclotrimer of 1,6-hexamethylene diisocyanate, i.e. the monoisocyanurate compound obtained by cyclotrimerization of 3 mol of HDI with itself, the cyclodimer of HDI, i.e. the uretidione compound obtained by cyclodimerization of 2 moles of HDI with itself, and also the biuret and allophanates derivatives of these compounds.

When the reaction medium of step b) is an organic medium, i.e. the aqueous phase thereof has optionally been removed, in particular by separation by settling out, the blocked isocyanate is obtained in solution or suspension in the organic medium depending on the nature of the blocking agent and/or the percentage of blocking groups present in the composition.

When it is desired to obtain a blocked isocyanate composition in aqueous emulsion, it is advantageous to carry out step a) in exclusively aqueous medium and to add to the reaction product obtained, before, during or at the end of step b), a surfactant. The addition of a surfactant is not, however, necessary, it being possible for the reaction to take place in heterogeneous medium.

The surfactant which is of use for the formation of the emulsion is selected from standard surfactants known to those skilled in the art for their emulsion-forming properties (for example polyethylene glycol monoalkyl ether).

The surfactant may either be foreign to the isocyanate, or may itself be an isocyanate and result from the reaction of an isocyanate on a precursor exhibiting a function with a reactive hydrogen (said precursor either exhibiting significant hydrophilicity, or itself already being amphiphilic), or may be a mixture of the two. This synthesis may either be carried out prior to the blocking, or may be carried out simultaneously.

The surfactants used may be nonionic with an HLB greater than 10, preferably of the order of approximately 10 to approximately 20, anionic, cationic, zwitterionic or amphoteric, advantageously with an HLB greater than approximately 10.

The nonionic surfactants may be selected from alkoxylated fatty acids, polyalkoxylated alkylphenols, polyalkoxylated fatty alcohols, polyalkoxylated or polyglycerolated fatty amides, polyglycerolated alcohols and alpha-diols, polyalkylene glycols, ethylene oxide/propylene oxide block polymers, and also alkylglucosides, alkylpolyglucosides, sugar ethers, sugar esters, sugar glycerides, sorbitan esters, and the ethoxylated compounds of these sugar derivatives advantageously exhibiting an HLB of at least approximately 10.

The anionic surfactants may be selected from alkylbenzenesulfonates, monoalkyl sulfates, alkyl ether sulfates, alkylaryl ether sulfates, dialkylsulfosuccinates, alkyl phosphates, and ether phosphates which are well dissociated, such as those constituting alkali salts, of ammoniums, advantageously quaternary ammoniums, advantageously exhibiting an HLB of at least approximately 10. Details of some preferred surfactants will be given below.

Among the cationic surfactants, mention may be made of aliphatic or aromatic fatty amines, aliphatic fatty amides, and quaternary ammonium derivatives advantageously exhibiting an HLB of at least approximately 10.

Among the zwitterionic or amphoteric surfactants, mention may be made of betaines and derivatives thereof, sultaines and derivatives thereof, lecithins, imidazoline derivatives, glycinates and derivatives thereof, amidopropionates, and oxides of fatty amines advantageously exhibiting an HLB of at least approximately 10.

In general, when these surfactants are nonionic surfactants, they have hydrophilic groups such as, for example, ethylene oxide groups, in sufficient number, generally greater than approximately 10, so as to allow the polyisocyanates, which may or may not be blocked, to be readily emulsified. The surfactants also have a hydrophobic component which may be selected from aromatic groups carrying aliphatic chains or simply from aliphatic chains containing between 8 and 50 carbon atoms. Other hydrophobic units, such as silicone units or fluorinated units, may also be used for particular applications.

Mention may be made, by way of nonlimiting examples, of derivatives of polyoxyalkylene esters of fatty acids, ethoxylated alkylphenols, phosphate esters containing a polyalkyloxyalkylene chain (such as polyoxy- and/or propoxyethylene glycol, for example), and tristyryl phenols containing a poly(ethylene oxide) chain.

Said surfactant may also consist of an agent (or a mixture of surfactants) which is neutral or which has an anionic function. The latter are preferred.

Thus, advantageously, said surfactant (or a mixture of surfactants) contains a compound comprising an anionic function and a fragment of a polyethylene glycol chain containing at least one, advantageously at least 5, preferably at least 7, alkyleneoxy units of formula:

—(CHR—CH₂—O)—

with R=H or CH₃, advantageously ethyleneoxy units.

Said surfactant (or one of its constituents) is advantageously based on a compound which has an anionic function. Surfactants of this type are described, for example, in WO 99/10402, to which reference may be made for further details.

A preferred surfactant is that in which the anion corresponds to the following formula:

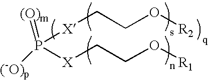

with, when q is zero:

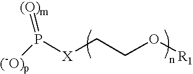

where p represents zero or an integer between 1 and 2 (closed intervals, i.e. limits inclusive);

where m represents zero or an integer between 1 and 2 (closed intervals, i.e. limits inclusive);

where the sum of p+m+q is at most equal to three;

where the sum 1+p+2 m+q is equal to three or to five;

where X and X′, which may be similar or different, represent an arm comprising at most two carbon linkages;

where n and s, which may be similar or different, represent an integer selected from between 5 and 30, advantageously between 5 and 25, preferably between 9 and 20 (closed intervals, i.e. limits inclusive);

where R₁ and R₂, which may be similar or different, represent a hydrocarbon-based radical, advantageously selected from aryls and alkyls optionally substituted in particular with a halogen, especially fluorine, atom. Phosphate and polyalkylene glycol esters are preferred.

Mention may in particular be made of mixtures of polyethoxylated phosphate mono- and diesters containing an average number of EO units of 3 to 20, advantageously of 8 to 15, and having an ethoxylated nonylphenol chain or an ethoxylated fatty acid chain, for example lauryl chain, or a C₈-C₂₀ hydrocarbon-based chain. Mention may in particular be made of the products sold under the trade name RHODAFAC®.

The counter-cation is advantageously monovalent and is selected from inorganic cations and organic cations which are advantageously normucleophilic and, consequently, quaternary or tertiary in nature (in particular column V oniums, such as phosphoniums, ammoniums, or even column VI oniums, such as sulfoniums, etc.), and mixtures thereof, most commonly ammoniums, generally derived from an amine, advantageously a tertiary amine. Advantageously, an organic cation exhibiting a hydrogen which is reactive with the isocyanate function is avoided, hence the preference for tertiary amines.

The inorganic cations may be sequestered by phase-transfer agents such as crown ethers. The pKa of the cations (organic [ammonium, etc.] or inorganic) is advantageously between 8 and 12.

When step a) is carried out in aqueous medium, it is also possible to obtain the final blocked (poly)isocyanate composition in aqueous-organic emulsion, by addition to the reaction medium, before, during or after step b), of a water-dispersible solvent. Mention may in particular be made of methyl phosphate, an ether or else hydrocarbons, preferably aromatic hydrocarbons, of the SOLVESSO® type.

It is advantageous, in this case, though not necessary, to add to the aqueous-organic medium a surfactant of the type described above in order to obtain a stable oil-in-water emulsion.

The method of the invention also makes it possible to obtain a highly concentrated, blocked (poly)isocyanate composition in organic solution. In this case, step a) may be carried out in aqueous medium and, at the end of step b), a hydrophilic solvent is added to the reaction medium, after which the organic and aqueous phases are left, and the very concentrated blocked (poly)isocyanate composition in organic solution is recovered. A preferred solvent for this purpose is n-butyl acetate.

A subject of the invention is also a partially or totally blocked (poly)isocyanate composition obtained by the method according to the invention.

The partially or totally blocked (poly)isocyanates according to the invention may be used as a basis for producing polymers and/or crosslinked materials, and may be used in particular as one of the main constituents of coatings of all types, such as varnishes and paints. In such uses, the qualities of hardness of crosslinkable polymers are among those which are desired from a technical and functional point of view.

This method for producing polymers comprises the following steps:

bringing a protected polyisocyanate according to the invention (I) into contact with a coreagent which contains derivatives exhibiting reactive hydrogens in the form of alcohol, of phenol, of thiol, of certain amines including anilines; these derivatives may have aliphatic, alicyclic or aromatic hydrocarbon-based backbones, preferably alkyl, including cycloalkyl and aralkyl, or aryl backbones, which may be linear or branched and which may be substituted or unsubstituted (these coreagents, in general polyols, are known in themselves);

and heating the reaction medium thus formed either at a high temperature for a short period of time or at a low temperature for a long period of time.

The first case corresponds to the technique often referred to as “coil coating” and corresponds to a duration of at most 15 minutes at 180° C. and of at most 5 minutes at 200° C., with, in addition, good resistance to coloration (in general yellowing) for cases where overcuring has taken place. This procedure is in general preferably carried out at a temperature of 150° C.±10° C.

In the other extreme, gentle curing is carried out, in general at a temperature of at most 160° C. for a duration of at most two hours, more commonly of at most one hour.

Advantageously, the temperature is at most equal to 150° C., preferably between 80° C. and 140° C., and even more preferably between 110° C. and 130° C., for a duration of less than or equal to 15 hours, preferably less than or equal to 10 hours, and even more preferably less than or equal to 8 hours.

The inclusion of an organic solvent in the reaction medium may be envisioned. A suspension in water may also be envisioned.

This optional solvent is as defined above. Relatively nonpolar solvents, i.e. for which the dielectric constant is barely greater than or is equal to 4, or more preferably to 5, are preferred.

The derivatives which make up the composition of the coreagent are in general di-, oligo- or polyfunctional. They may be monomers or may be derived from dimerization, oligomerization or polymerization, and are used for producing optionally crosslinked polyurethanes. The choice thereof will be dictated by the functionalities expected for the polymer in the final application and by their reactivity.

The use of derivatives exhibiting reactive hydrogens which catalyze the release of the blocked isocyanate is preferably avoided. Thus, among the amines, it is preferred to use only those which do not catalyze the decomposition or the transamidation of the isocyanate functions blocked according to the present invention. These coreagents are generally well known to those skilled in the art.

The invention therefore also relates to paint compositions comprising, for successive or simultaneous addition:

a blocked (poly)isocyanate according to the invention;

a coreagent with a reactive hydrogen as described above;

optional catalysts, known in themselves, for oximes, pyrazoles and/or hydrazones, in particular those which are tin-based;

optionally at least one pigment;

optionally titanium dioxide;

optionally an aqueous phase;

optionally a surfactant for maintaining the components constituting the mixture in emulsion or in suspension;

optionally an organic solvent;

optionally a dehydrating agent.

The invention also relates to the paints and varnishes obtained using these compositions, according to the method above.

The invention is illustrated by the following examples:

In the following examples, reference will be made to these IR bands for the characterization of the products.

Infrared Bands of the Characteristic Functions of the Free or Blocked Polyisocyanates:

The infrared analysis of the finished product is carried out on a KBr pellet, after evaporation of the solvents and of the water at ambient temperature. The dry extract is then examined in film on a KBr wafer.

Characteristic Bands of the HDT Polyisocyanates with Isocyanate Functions Blocked with 3,5-dimethylpyrazole

—NCO: 2250 cm⁻¹

C═O isocyanurate: 1688 cm⁻¹ and 1465 cm⁻¹

Bands for blocking with 3,5-dimethylpyrazole:

—C═O blocking: 1720 cm⁻¹ and —C(═O)—NH— blocking: 1518 cm⁻¹

NH— at 3398 cm⁻¹

Characteristic Bands of the HDT Polyisocyanates with Isocyanate Functions Blocked with Methyl Ethyl Ketoxime

NCO: 2250 cm⁻¹

C═O isocyanurate: 1688 cm⁻¹ and 1465 cm⁻¹

Bands for MEKO blocking:

C═O blocking: 1731 cm⁻¹ and —C═O—NH— blocking:

1508 cm⁻¹

Characteristic Bands of the HDT Polyisocyanates with Isocyanate Functions Blocked with Alkyl Pyruvate Oxime

NCO: 2250 cm⁻¹

C═O isocyanurate: 1688 cm⁻¹ and 1465 cm⁻¹

Bands for oxime blocking: C═O blocking: 1731 cm⁻¹ and —C═O—NH-blocking: 1508 cm⁻¹

Ester bands: 1732 cm⁻¹

### EXAMPLE 1

Synthesis of an Aqueous Suspension of 3,5-dimethylpyrazole

135 g of hydrazine hydrate at 51% by weight in water, i.e. 2.15 mol of hydrazine, are successively introduced, at ambient temperature, into a thermostated 1 liter reactor equipped with a refrigerant, a thermometer and a conventional stirring device. 47 g of water are then added.

200 g of acetyl acetone (2 mol) are added to the reaction medium over 2 hours 45 minutes, while maintaining the temperature at around 50° C.

When the addition has been completed, the temperature of the reaction medium is brought to 70° C. for a further 2 hours in order to ensure finishing of the reaction.

The aqueous solution of DMP can be used as it is or it can be diluted so as to obtain a 40% aqueous suspension of DMP in water.

The DMP formed precipitates during cooling of the solution. The structure of the product obtained is confirmed by infrared analysis and NMR.

The aqueous solution of hydrazine hydrate is preferably used as source of hydrazine since it does not lead to the coproduction of salts.

Another pathway for synthesizing the 3,5-dimethylpyrazole, described in Vogel's Textbook of Practical Organic Chemistry, 5^{th} edition, John Wiley and Sons, New York, on page 1149, uses hydrazine sulfate and leads to the production of salts (sodium sulfate) which must be removed before or after blocking of the isocyanate functions.

In the following examples, use will be made of a 39% aqueous DMP solution (suspension at ambient temperature) derived from this example and therefore free of salts.

### EXAMPLE 2

Synthesis of an HDT-3,5-dimethylpyrazole Blocked Polyisocyanate Composition

365 g of an aqueous suspension of 3,5-dimethylpyrazole (DMP) containing 40% of solids, i.e. 146 g of 3,5-DMP, prepared as described in example 1, are introduced, at ambient temperature, into a thermostated 1 liter reactor equipped with a refrigerant, a thermometer and a conventional stirring device.

The reaction medium is heated to a temperature of 60° C., at which temperature the DMP slowly dissolves.

380 g of a solution of polyisocyanate based on hexamethylene diisocyanate trimer (isocyanurate) (TOLONATE HDT) in n-butyl acetate (n-Bu AcO) (i.e. 253 g of HDT containing 0.52 mol of NCO per 100 g dissolved in 127 g of n-Bu AcO) are added to the stirred reaction medium, over 1 hour 45 minutes.

The temperature of the reaction medium is brought to 80° C. for one hour 40 minutes, until infrared analysis of a sample of reaction mass indicates the absence of an isocyanate band at 2250 cm⁻¹.

100 g of water and 86 g of n-butyl acetate are added to the reaction medium, and the reaction medium is separated by settling out. The organic phase is washed with 450 g of water and further separation by settling out is carried out.

The aqueous-organic phase containing the HDT polyisocyanate blocked with DMP (437 g) is then stored in a container without additional desiccation.

Assaying of this organic phase indicates the presence of 2% of water by weight.

The amount of n-butyl acetate assayed by ¹H NMR is 36.3%. The content of DMP-blocked HDT in the final organic solution is 62%.

The infrared spectrum of the emulsion shows that the HDT-DMP product formed is virtually identical to a solution of HDT-DMP blocked polyisocyanate obtained according to a conventional organic-phase method starting from dry powdered 3,5-dimethylpyrazole.

The solution of DMP-blocked HDT polyisocyanate is used as it is in the application tests (cf. application examples).

If a higher solids content is desired, it is possible to distil some of the solvent by evaporation under partial vacuum at a maximum temperature of 80° C.

It is also shown that the addition of alcohol (1 g of ethanol) to 1.5 grams of aqueous-organic solution of DMP-blocked HDT results in a completely homogeneous and translucent solution.

### EXAMPLE 3

Synthesis of an HDT-3,5-dimethylpyrazole Blocked Polyisocyanate Composition

The procedure for example 2 is carried out, using 314 g of a 39% aqueous DMP suspension obtained according to Example 1 (122.5 g of DMP and 191.5 g of water).

The organic solution of HDT polyisocyanate (245.5 g in 122.7 g of n-butyl acetate) is added to the reaction medium over 50 minutes approximately at 60° C. After addition of all the HDT solution, the temperature of the reaction medium is brought to 80° C. After finishing for 1 hour 20 minutes at 80° C., the solution is separated by settling out. 170.5 g of aqueous phase are removed.

The organic phase is adjusted such that the solids content is of the order of 69%.

Solvent analysis shows the following distribution: water: 1.6% by weight, and n-butyl acetate: 29.5% by weight.

The potential NCO titer is 10.03%.

Infrared analysis on KBr film after evaporation of the solvents is characteristic of the spectrum of the 3,5-dimethylpyrazole-blocked HDT, and shows an absence of free isocyanate functions.

### EXAMPLE 4

Synthesis of an HDT-3,5-dimethylpyrazole Blocked Polyisocyanate Composition

The procedure is carried out as for example 3, using 340 g of a 39% aqueous DMP suspension obtained according to Example 1 (122.5 g of DMP and 191.5 g of water).

The organic solution of HDT polyisocyanate (265.8 g in 132.8 g of triethyl phosphate) is added to the reaction medium over approximately 15 minutes. The temperature of the reaction medium increases from 60° C. at the beginning of addition to 75° C. at the end of addition. The reaction mixture is left stirring for 2 hours at 80° C. for finishing of the blocking reaction.

The solution is then separated by settling out and 233.5 g of phase are removed.

After addition of 233.5 g of triethyl phosphate to the organic phase, a clear aqueous-organic blocked polyisocyanate solution, with a 54% HDT-DMP solids content and a viscosity equal to 330 mPa.s at 25° C., is obtained.

Solvent analysis shows the following distribution: water: 28.1% by weight and triethyl phosphate: 18% by weight.

The potential NCO titer is 0.239, i.e. 10%.

Infrared analysis on KBr film after evaporation of the solvents is characteristic of the spectrum of the 3,5-dimethylpyrazole-blocked HDT and shows an absence of free isocyanate functions.

### EXAMPLE 5

Synthesis of an HDT-3,5-dimethylpyrazole Blocked Polyisocyanate Composition

The procedure is carried out as for example 4, using 287 g of a 39% aqueous DMP suspension obtained according to Example 1 (112 g of DMP and 175 g of water).

The HDT polyisocyanate (224.3 g) is added directly to the reaction medium over approximately 40 minutes. The temperature of the reaction medium is maintained at 60° C. Once the addition of the HDT is finished, 21.5 g of N-methylpyrrolidone, i.e. 6% by weight, are run into the reaction medium and the temperature is increased to 75° C. The reaction medium is left stirring for 2 hours at 85° C. for finishing of the blocking reaction.

The solution, with a 63% HDT-DMP solids content, is then stored.

During storage, separation by settling out into two phases is observed, which indicates that N-methylpyrrolidone is not the best solvent for formulating the HDT-DMP.

### EXAMPLE 6

Synthesis of an Aqueous-Organic Solution of DMP-Blocked HDT

A solution of HDT in n-butyl acetate (382.4 g of HDT in 41.6 g of n-butyl acetate) is added to the reaction medium of example 1 over 55 minutes and at 70° C. approximately. The temperature of the reaction medium increases to 75° C.

Separation of the reaction medium by settling out into two phases is then carried out and, after removal of most of the water, the organic phase is drained off into a storage container.

Infrared analysis indicates an absence of isocyanate bands at 2500 cm⁻¹ and the presence of urea bands corresponding to the blocking.

### EXAMPLE 7

Synthesis of an Aqueous-Organic Solution of DMP-Blocked HDT

The procedure is carried out as for the preceding example 6, with the difference that the solution of HDT is a solution in a mixture of Solvesso® 100/n-butyl acetate (50/50) by weight.

The presence of Solvesso® results in the separation by settling out being more difficult, and a whitish milky emulsion of DMP-blocked HDT is obtained.

### EXAMPLE 8

Synthesis of an Aqueous-Organic Solution of DMP-Blocked HDT

The procedure is carried out as for example 4, using 370 g of a 39% aqueous DMP suspension obtained according to example 1 (148 g of DMP (1.54 mol) and 222 g of water).

The solution of HDT polyisocyanate (297 g with an NCO titer of 0.519 mol of NCO per 100 g) in Solvesso® 100 (148.2 g) is added directly to the reaction medium over 1 hour. The temperature of the reaction medium is maintained at 35° C. As soon as the addition of HDT has ended, the viscosity of the medium increases and the temperature of the reaction medium is brought to 75° C. in order to facilitate stirring.

The reaction medium is left stirring for 2 hours approximately at 75° C. for finishing of the blocking reaction (control of isocyanate functions by IR).

The solution is drained off under hot conditions, so as to give, under cold conditions, an aqueous-organic emulsion of HDT with DMP-blocked isocyanate functions, the solids content of which is 49%.

The amount of free dimethylpyrazole is 0.03%.

Solvent analysis gives the following distribution: Solvesso® 100: 19.5% and water: 30.5% by weight.

During storage, separation by settling out into two phases is observed, but the HDT-DMP blocked polyisocyanate is, on the other hand, stable.

### EXAMPLE 9

Method for Producing a Composition Based on Isocyanurate Trimer of Hexamethylene Diisocyanate with Isocyanate Functions Blocked with Methyl Pyruvate Oxime

83 g of 99% pure hydroxylamine sulfate, i.e. 0.5 mol, and 240 g of water are introduced successively, at ambient temperature, into a thermostated 1 L reactor equipped with a refrigerant, a thermometer and a conventional stirring device. The temperature of the reaction medium decreases from 20.7° C. to 15.5° C.

An organic solution of methyl pyruvate is prepared by mixing 118.5 g of this compound with 120 g of n-butyl acetate.

This solution is added to the reaction medium over 1 hour.

10 minutes after this solution has begun to be run in (approximately 40 mL), 250 g of a 4N aqueous sodium hydroxide solution are added in parallel, over approximately 1 hour. The temperature of the reaction medium increases from 15.5° C. to 45° C. at the end of the reaction.

After 3 hours at 40° C., separation of the organic phase by settling out is performed, as are two washes of the organic phase with 2 times 50 g of water in order to remove most of the sodium sulfate formed.

534 g of aqueous phase and 102.5 g of aqueous washing phases are removed.

193 g of polyisocyanate TOLONATE-HDT, with an NCO function titer of 0.519 per 100 g, are added, over 2 hours with a temperature gradient of 40° C., to the aqueous-organic phase of methyl pyruvate oxime (269 g) brought to 40° C. with stirring.

The temperature profile selected for this addition is as follows: 1 hour at 40° C. followed by an increase to 85° C. over 30 minutes and maintaining the temperature for 1 hour.

The absence of free isocyanate functions is controlled by infrared analysis.

437 g of an aqueous-organic composition with a 74% content of solids of polyisocyanate-tolonate-HDT with isocyanate functions blocked with methyl pyruvate oxime, with a viscosity at 25° C. of 1380 mPa·s and a potential NCO titer equal to 16.14% (0.384 mol of NCO per 100 g), are thus obtained.

The structure of the product obtained is confirmed by infrared analysis and NMR.

### EXAMPLE 10

Method for Producing a Composition Based on Isocyanurate Trimer of Hexamethylene Diisocyanate with Isocyanate Functions Blocked with Methyl Pyruvate Oxime

The procedure is carried out as for example 9, except that the separation by settling out the aqueous phase loaded with sodium sulfate after formation of the methyl pyruvate oxime is not carried out, and the blocking reaction is carried out on the two-phase unseparated reaction medium by adding the HDT to the reaction medium.

At the end of the blocking reaction, determined by infrared analysis, the saline aqueous phase is then separated from the organic phase containing the polyisocyanate-Tolonate-HDT with isocyanate functions blocked with methyl pyruvate oxime, by settling out.

The organic phase is washed with two times 100 mL of distilled water in order to remove the residual traces of sodium sulfate.

A solution of polyisocyanate-Tolonate-HDT with isocyanate functions blocked with methyl pyruvate oxime, with a 75% solids content and a viscosity equal to 1500 mPa·s at 25° C., is thus obtained.

Conclusion: This example shows that it is possible to link the synthesis of the blocking agent and the blocking of the isocyanate functions of a polyisocyanate in a two-phase medium without intermediate isolation of the blocking agent. The removal of the salts can be delayed until after the blocking reaction.

### EXAMPLE 11

Synthesis of an Aqueous Suspension of 3,5-dimethylpyrazole in SOLVESSO® 100

The procedure is carried out as for example 1. A variation is added to the final treatment.

350 mL of trimethylbenzene (SOLVESSO® 100) are added to the aqueous DMP solution.

The water is then removed by azeotropic distillation of the reaction mixture.

After removal of the water, the solution is allowed to cool. A suspension of DMP in Solvesso® 100 is thus obtained, which is then used for blocking the isocyanate functions of a polyisocyanate in organic phase. The concentration of DMP in the Solvesso® 100 is of the order of 46%.

### EXAMPLE 12

Preparation of an Organic Composition of HDT Polyisocyanate with Isocyanate Functions Blocked with 3,5-dimethylpyrazole in SOLVESSO® 100

The suspension of DMP in Solvesso® 100 prepared as described in example 11 is used.

The suspension of DMP in Solvesso® 100, i.e. 152.5 g of DMP in 174.5 g of Solvesso® 100, i.e. 1.59 mol of DMP, is introduced, at ambient temperature, into a thermostated 1 L reactor equipped with a refrigerant, a thermometer and a conventional stirring device.

302 g of polyisocyanate-tolonate-HDT having an isocyanate function content of 0.519 mol per 100 g are added to this suspension, over one hour. The temperature of the reaction medium thus increases from 23° C. to 52° C. When addition of the HDT polyisocyanate is finished, the reaction medium is heated at 80° C. for a further 1 hour 15 minutes in order for the blocking reaction to be complete.

625 g of a solution of HDT with DMP-blocked isocyanate functions, the solids content of which is 73.4% and the potential isocyanate function content of which is 10.5%, are thus obtained.

The amount of free 3,5-dimethylpyrazole in the final solution is 0.07%.

Solvent analysis gives the following distribution:

25.5% of Solvesso® 100;

1.1% of water.

The infrared spectrum is in accordance with that of the expected infrared spectrum.

This example shows that the linked method (blocking agent synthesis—isocyanate function-blocking reaction) makes it possible to obtain a solution with a high solids content without intermediate isolation of the blocking agent and therefore without loss of the latter.

### COMPARATIVE EXAMPLE 13

Synthesis of an Organic Solution of DMP-Blocked HDT According to a Conventional Method

258 g of n-butyl acetate solvent and 242 g of 3,5-dimethylpyrazole (i.e. 2.52 mol) are introduced, at ambient temperature, into a thermostated 1 L reactor equipped with a refrigerant, a thermometer and a conventional stirring device. The temperature of the reaction medium is brought to 60° C. and 500 g of HDT polyisocyanate containing 0.52 mol of NCO per 100 g are added over a period of one hour. The temperature of the reaction medium increases from 60° C. to 80° C. After finishing for 1 hour at 80° C., the infrared spectrum shows an absence of band corresponding to the isocyanate band. 960 g of organic solution of DMP-blocked HDT polyisocyanate are packaged in a 500 mL bottle.

This composition has a 74% solids content, a potential NCO titer of 10.6% and a viscosity of 1210 mPa·s at 25° C.

The solids content is adjusted to an amount of 70% in order to be able to use this derivative in the application tests.

This composition is used to carry out comparative tests (example 14).

### EXAMPLE 14

Comparative Application Tests

A coating obtained with an HDT polyisocyanate blocked with DMP according to the claimed linked method: blocking agent synthesis—blocking of HDT isocyanate functions (example 3) and a polyisocyanate of the same HDT nature with DMP-blocked isocyanate functions, obtained according to a conventional method (example 13) are compared.

The results obtained with the hardener of example 3, which is the subject of the invention, are comparable to those obtained with comparative example 13. This shows that the method of synthesis developed does not have a negative influence on the film properties.

Composition of the formulations of examples 3 and 13:

| | % NCO | SC |
|---|---|---|
| Polyisocyanate of example 3 | 10.03 | 69 |
| Polyisocyanate of example 13 | 10.2 | 70 |

| Raw material | Type | Supplier | Weight (g) |
|---|---|---|---|
| Vialkyde AN 927/70X | alkyde resin | Solutia | 22.45 |
| Kronos 2310 | titanium dioxide | Kronos | 13.55 |
| blanc fixe micro | filler | Sachtleben | 18.5 |
| Noir SP 4 | pigment | Degussa | 0.04 |
| aerosol R972 | silica | Degussa | 0.3 |
| Solvant RPDE | solvent | Rhodia | 6 |
| Byk 358 | additive | Byk | 0.6 |
| additol VXL6212 | welling agent | Solutia | 0.2 |
| AMP | solvent | | 0.2 |
| Disparlon L1984 | anti-bubble | SCC | 0.3 |
| Solvesso 100 | solvent | | 13 |
| Vialkylde AN 903/70X | alkyde resin | Solutia | 9.6 |
| Maprenal MF 980/62B | melamine | | 5.55 |
| Total | | | 90.29 |
| addition of hardener | | Example 3 | 13.09 |
| addition of hardener | | Comparative | 13.18 |
| | | example 13 | |

placed at viscosity 50s, Ford 4 cup, by addition of Solvesso ® 100/butyl acetate application with film spreader,
100 μm humid, on steel plates 30 min of desolvatation, then curing for 30 min at 140, 150 or 160° C.

| | Results of the application tests | | | | | | | |
|---|---|---|---|---|---|---|---|---|
| | | Tests after 1 h | | Tests at 7 days | | | | |
| | Curing: | Double | Persoz | Brilliance | Persoz | Afnor | ASTM | Erichsen |
| | 30 min at | rub MEK | hardness | 20°/60° | hardness | impact | impact | cupping |
| HDT DMP | 140° C. | >200 | 112 | 69/93 | 112 | >100 cm | >80 in | >9 mm* |
| aqueous | 150° C. | >200 | 112 | 72/93 | 112 | >100 cm | >80 in | 8.9 mm |
| (linked method) | 160° C. | >200 | 113 | 66/93 | 116 | >100 cm | >80 in | >9 mm* |
| example 3 | | | | | | | | |
| DMP-blocked | 140° C. | | 119 | 69/93 | 115 | >100 cm | >80 in | >9 mm* |
| HDT | 150° C. | >200 | 110 | 62/92 | 108 | >100 cm | >80 in | >9 mm* |
| comparative | 160° C. | >200 | 117 | 65/92 | 115 | >100 cm | >80 in | >9 mm* |
| example 13 | | | | | | | | |

1-20. (canceled).

21. A method for producing (poly)isocyanates blocked using a blocking agent selected from the blocking agents exhibiting a C═N bond and having a mobile hydrogen atom on the atom in the α-position relative to the nitrogen atom of the C═N group, and the blocking agents of formula I or of formula II or of formula III: 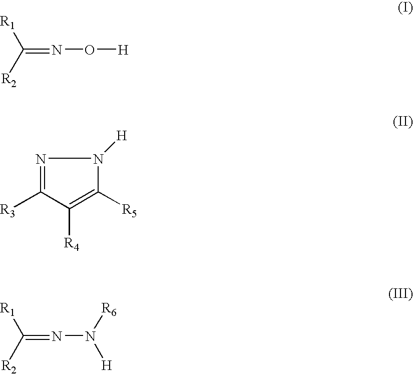
in which:
R₁ and R₂ are selected from an alkyl group, perhaloalkyl group, cycloalkyl group, aryl group, alkoxy group, acyl group, acyloxy group, aryloxy group, alkoxycarbonyl group and aryloxycarbonyl group, optionally substituted, and/or interrupted with one or more hetero atoms selected from S, O and N;
R₃, R₄ and R₅ are selected from a hydrogen atom, and an alkyl group, perhaloalkyl group, cycloalkyl group, aryl group, alkoxy group, aryloxy group, acyl group, acyloxy group, alkoxycarbonyl group and aryloxycarbonyl group, optionally substituted, and/or interrupted with one or more hetero atoms selected from S, O and N;
R₆ represents a hydrogen atom, an alkyl group, cycloalkyl group or aryl group, as defined above, or a carbamoyl group of formula CONR₇R₈, R₇ and R₈ possibly being selected, independently of one another, from an alkyl group, cycloalkyl group or aryl group, which is optionally substituted,
which method comprises the following steps:
a) producing a blocking agent exhibiting a C═N bond and having a mobile hydrogen atom on the atom in the α-position relative to the nitrogen atom of the C═N group, a blocking agent of formula I or of formula II or of formula III, by condensation of a precursor comprising an aldehyde or a ketone with a nitrogen-containing precursor comprising a functional group reactive toward the carbonyl function of the aldehyde or of the ketone, in aqueous, organic or aqueous-organic medium, with release of condensation water, the water produced for the production of the compounds of general formula I or III being optionally eliminated;
b) reacting the blocking agent, in the reaction medium obtained at the end of step a) without subsequent treatment thereof, with a (poly)isocyanate composition to be blocked so as to obtain said totally or partially blocked (poly)isocyanates.

22. The method as claimed in claim 21, wherein said mobile hydrogen atom in the α-position relative to the nitrogen atom of the C═N group is carried by an oxygen or nitrogen atom.

23. The method as claimed in claim 21, wherein, in step a), hydroxylamine is reacted with a ketone so as to obtain an oxime of general formula I: 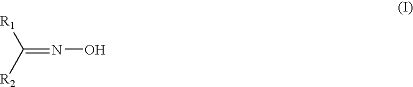
in which R₁ and R₂ are selected from an alkyl group, perhaloalkyl group, cycloalkyl group, aryl group, alkoxy group, acyl group, acyloxy group, aryloxy group, alkoxycarbonyl group and aryloxycarbonyl group, optionally substituted, and/or interrupted with one or more hetero atoms selected from S, O and N.

24. The method as claimed in claim 21, wherein, in step a), hydrazine is reacted with a β-diketone so as to obtain a pyrazole compound of general formula II: 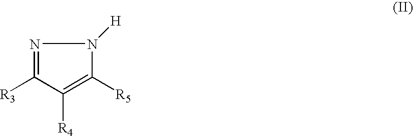
in which R₃, R₄ and R₅ are selected from a hydrogen atom, and an alkyl group, perhaloalkyl group, cycloalkyl group, aryl group, alkoxy group, aryloxy group, acyl group, acyloxy group, alkoxycarbonyl group and aryloxycarbonyl group, optionally substituted, and/or interrupted with one or more hetero atoms selected from S, O and N.

25. The method as claimed in claim 21, wherein, in step a), an optionally substituted hydrazine is reacted with a ketone so as to obtain a compound of general formula III: 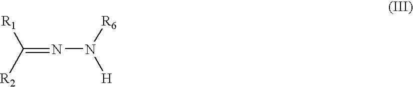
in which:
R₁ and R₂ are selected from an alkyl group, perhaloalkyl group, cycloalkyl group, aryl group, alkoxy group, acyl group, acyloxy group, aryloxy group, alkoxycarbonyl group and aryloxycarbonyl group, optionally substituted, and/or interrupted with one or more hetero atoms selected from S, O and N; and
R₆ represents a hydrogen atom, an alkyl group, cycloalkyl group or aryl group, as defined above, or a carbamoyl group of formula CONR₇R₈, R₇ and R₈ optionally being selected, independently of one another, from an alkyl group, cycloalkyl group or aryl group, which is optionally substituted.

26. The method as claimed in claim 21, wherein the compound obtained at the end of step a) is methyl ethyl ketoxime (MEKO), benzophenone oxime, an alkyl pyruvate oxime, ethyl pyruvate oxime, or cyclohexanone oxime.

27. The method as claimed in claim 24, wherein the compound obtained at the end of step a) is pyrazole, 3-methylpyrazole or 3,5-dimethylpyrazole.

28. The method as claimed in claim 25, wherein the compound obtained at the end of step a) is acetaldehyde hydrazone, acetone methylhydrazone, cyclopentanone methylhydrazone or methyl ethyl ketone methylhydrazone.

29. The method as claimed in claim 21, wherein step a) is carried out in organic or aqueous-organic medium.

30. The method as claimed in claim 21, wherein step a) is carried out in aqueous medium.

31. A method for producing a solution or suspension in organic medium of a (poly)isocyanate blocked using an agent for blocking the NCO function, selected from oximes, pyrazoles and hydrazones, as claimed in claim 21, wherein step a) is carried out in organic medium.

32. A method for producing an aqueous emulsion of (poly)isocyanate blocked using an agent for blocking the NCO function, selected from oximes, pyrazoles and hydrazones, as claimed in claim 21, wherein step a) is carried out in aqueous medium and in that, before, during or after step b), a surfactant is added to the reaction medium.

33. The method as claimed in claim 32, wherein the surfactant is an anionic agent in which the anion corresponds to the formula below: 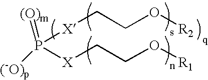
where p represents zero or an integer between 1 and 2 (closed intervals);
where m represents zero or an integer between 1 and 2 (closed intervals);
where the sum of p+m+q is at most equal to three;
where the sum 1+p+2 m+q is equal to three or to five;
where X and X′, which may be similar or different, represent an arm comprising at most two carbon linkages;
where n and s, which may be similar or different, represent an integer selected from between 5 and 30 (closed intervals);
where R₁ and R₂, which may be similar or different, represent a hydrocarbon-based radical, optionally selected from aryls and alkyls optionally substituted with a halogen atom.

34. A method as claimed in claim 21 for producing a blocked (poly)isocyanate in aqueous-organic emulsion, wherein step a) is carried out in aqueous medium and in that, before, during or after step b), a water-dispersible solvent is added to the reaction medium.

35. The method as claimed in claim 34, wherein a surfactant is also added to the reaction medium.

36. The method as claimed in claim 21, wherein the polyisocyanate is an alkylene diisocyanate or a product of homocondensation or heterocondensation of alkylene diisocyanates comprising products of the “BIURET” type, of the “TRIMER” type or of the “PREPOLYMER” type, with isocyanate functions comprising urea, urethane, allophanate, ester or amide functions, or mixtures of products mentioned above.

37. The method as claimed in claim 36, wherein the polyisocyanate is selected from hexamethylene diisocyanate and its products of homocondensation or polycondensation of the biuret, trimer and prepolymer type.

38. A partially or totally blocked (poly)isocyanate composition obtained by the method as claimed in claim 21.

39. A composition for coating, comprising, for successive or simultaneous addition:
a) a partially or totally blocked (poly)isocyanate composition as claimed in claim 38;
b) a coreagent with a reactive hydrogen.

40. A method for producing polymers, which comprises the following steps:
a) bringing a partially or totally blocked (poly)isocyanate as claimed in claim 38 into contact with a coreagent which contains derivatives exhibiting reactive hydrogens; and
b) heating the reaction medium thus formed at a temperature which allows crosslinking of the (poly)isocyanate with the coreagent.
